(19) United States
(12) Patent Application Publication
(10) Pub. No.: US 2005/0058827 A1
(43) Pub. Date: Mar. 17, 2005

(54) Coating material, coating and aluminum foil

(75) Inventors: Hans-Jurgen Arning, Lubbecke (DE); Frank Gross, St. Ingbert (DE); Reimund Krechan, Marpingen (DE); Stefan Sepeur, Wadgassen (DE)

Correspondence Address: VENABLE, BAETJER, HOWARD AND CIVILETTI, LLP, P.O. BOX 34385, WASHINGTON, DC, 20043-9998, US

(73) Assignees: Cofresco Frischhalteprodukte GmbH & Co. KG, Minden (DE); NANO-X Gmbh, Saarbrucken (DE)

(21) Appl. No.: 10/947,224

(22) Filed: Sep. 23, 2004

Related U.S. Application Data
(63) Continuation of application No. 10/860,596, filed on Jun. 4, 2004, now abandoned.

(30) Foreign Application Priority Data
Jun. 4, 2003 (DE) 203 08 885.9

(51) Int. Cl. B32B 5/16; B32B 15/04; B32B 17/06

(52) U.S. Cl. 428/323; 428/429; 428/450

(57) ABSTRACT

A coating material, in particular for high temperature applications, comprises a binding agent and at least one filler material, which can be deposited on a metal surface. For this, the binding agent contains at least one siloxane with an organic residual share of less than 25 weight %. It is preferable if the siloxane or siloxanes is (are) cross-linked three and/or four times.

### CROSS-REFERENCE TO RELATED APPLICATION

This application is a continuation of U.S. Ser. No. 10/860,596 filed Jun. 4, 2004 which is relied upon and incorporated by reference, which application Ser. No. 10/860,596 claims the priority of German Patent Application No. 203 08 885.9 filed Jun. 5, 2003, the subject matter of which is also incorporated herein by reference.

### BACKGROUND OF THE INVENTION

The present invention relates to a coating material, in particular a coating material that can be used for high temperatures, comprising a binding agent and at least one filler material, which can be deposited on a metal surface. The invention further relates to a corresponding coating and an aluminum foil.

Existing coating materials comprise a binding agent and at least one pigment and can be used for the temperature range of up to 700° C. These coating materials use methyl silicone resins, methyl phenyl silicone resins or phenyl silicone resins, which are colored with carbon black or inorganic color pigments (iron oxide black and others) and are used for painting mufflers, for grills, for waffle iron coatings and the like, wherein other color pigments can be used as well. Phenyl silicone resins, however, have the disadvantage that benzole-containing poisonous derivatives develop during the combustion. As a result, these types of coatings are suitable for high temperatures, but not for open flames and/or the food sector. With pure methyl silicone resins, a thermal degradation starts at 250° C. A complete compacting (crosslinking) is achieved only starting at 400° C., so that for the standard oven and grill temperature range of 200 to 400° C. no durable layers can be obtained.

### SUMMARY OF THE INVENTION

Thus, it is the object of the present invention to create a coating material, a coating and an aluminum foil which can be used even at high temperatures and in the food sector.

According to the invention, a coating material comprising a binding agent and at least one filler material is provided, which can be deposited on a metal surface, wherein the binding material contains at least one siloxane with a residual organic share of less than 25 weight %. The siloxane or siloxanes can be three- and/or four-times cross-linkable (by which is meant that each siloxane contains at least three groups which can engage in a cross-linking reaction), so that the filler material, e.g. carbon black, is vitrified in a matrix system and does not degrade in the temperature range that is relevant for the food sector for example at room temperature to 600°, preferably 100° C. to 400° C. In particular, in the temperature range between 200 and 400° C., which is standard for grilling temperatures, the coating material can thus also be used for the food sector, meaning it can be used as coating for grill surfaces, cooking equipment or even for aluminum foil. It is furthermore also possible to apply a coating by means of spraying, immersing, or other technique.

The coating material is preferably also provided with condensation catalysts, such as alkoxides, salts or nano particles of aluminum, zircon, titanium, and the like, which are preferably present in the oxidized form in the matrix.

The coating preferably has a thickness between 100 nm and 5 μm, in particular between 250 nm and 3 μm. As a result of the relatively thin embodiment of the coating material, it can be applied easily to a foil, for example an aluminum foil, wherein the shaping characteristics of the foil are not negatively affected. The coating can then be folded together with the foil, without the coating spalling off. The aluminum foil, coated according to the invention, can be used advantageously for cooking foods since the coating is heat-resistant and suitable for use with food items. The connection between aluminum foil and coating can furthermore be such that it has a good abrasion-resistance for the contact with water, oil, fat or vinegar. The coating may be supported on various substrates selected from the group consisting of metal, glass, ceramics, glass-ceramics, plastic, natural compound, textiles, paper or leather.

With the method according to the invention for producing the aluminum foil, the coating material according to the invention is initially deposited and the aluminum foil together with the coating material is heated in a further step to at least 180° C., preferably 220° C., and the coating material hardened in this way.

For an economical application of this layer, high belt speeds of 40 m/min are required, for example, and thus also short drying times. For that reason, the solvent used must extremely volatile, so that the solvent residues in the black layer do not evaporate at a -later sate of processing (or use) for example during the baking in the oven. Ethanol and isopropanol are therefore preferably used as solvents for the coating material since these substances have a good flow on the metal substrate and a low boiling point of 78° C. and/or 82° C.

However, if butylglycol is used, the layer does not harden completely under the same application conditions. Butylglycol residues that are not visible remain in the coating and the adherence of the coating to the aluminum layer worsens and thus also the deep-drawing and crush-resistant characteristics.

In the following, the invention is explained in further detail with the aid of several exemplary embodiments.

### DETAILED DESCRIPTION OF THE INVENTION

A coating material with the following components is produced as shown in the following:

a. The amount of 10.89 g 1% H₂SO₄ is added to 8,9 g (0.05 mol) methyltriethoxysilane (MTEOS) and 10.40 g (0.05 mol) tetraethoxysilane (TEOS), the mixture stirred for 1 h at room temperature (RT) at 700 rpm and then thinned down with 38.5 g isopropanol to obtain 10% solid matter. The amount of 2.02 g carbon black FW200 is then added to the binding agent for the black coloring and the mixture dispersed for 10 min at stage 3 (16000 rpm) into a homogenizer, e.g. the Ultraturrax®.

b. The amount of 14.54 g 1% H₂SO₄ is added to 20.80 g (0.1 mol) tetraethoxysilane (TEOS), the mixture stirred for 1 h at room temperature (RT) at 700 rpm and then thinned down with 24.73 g isopropanol to obtain 10% solid matter. The amount of 1.80 carbon black FW200 is then added to the binding agent for the black coloring and this mixture is dispersed for 10 min at stage 3 (16000 rpm) into a homogenizer, e.g. the Ultraturrax®.

c. The amount of 14.54 g 1% H₂SO₄ is added to 20.80 g (0.1 mol) tetraethoxysilane (TEOS), the mixture stirred for 1 h at room temperature (RT) at 700 rpm and then thinned down with 24.73 isopropanol to obtain 10% solid matter. 1 g 10% zircon acetate solution is added as catalyst. The amount of 1.80 carbon black FW200 is then added to the binding agent for the black coloring and this mixture dispersed for 10 min at stage 3 (16000 rpm) into a homogenizer, e.g. the Ultraturrax®.

d. The amount of 10.89 g 1% H₂SO₄ is added to 17.80 g (0.1 mol) methyltriethoxysilane (TEOS), the mixture stirred for 1 h at room temperature (RT) at 700 rpm and then thinned down with 24.73 isopropanol to obtain 10% solid matter. 1 g 10% zircon acetate solution is added as catalyst. The amount of 2.20 carbon black FW200 is then added to the binding agent for the black coloring and this mixture dispersed for 10 min at stage 3 (16000 rpm) into a homogenizer, e.g. the Ultraturrax®

The coating material obtained in this way is subsequently processed further.

Depending on the solid matter content, the material is applied to the object to be coated, e.g. a grill or cooking equipment, with the aid of a blade-roller or a pure roller. It is furthermore also possible to apply a coating by means of spraying, immersing, or other technique.

With the above examples a) and b), a 10 mm blade is used for a 10 μm wet-film cover. With a solid density of 0.8 g/cm³ (IPA) and 2.2 g/cm³ for an amorphous SiO₂ grid, a dry layer thickness of approximately 300 to 400 nm is obtained. The layer thickness can range between 100 nm and 5 μm and is preferably between 250 nm and 3 μm.

The coating is preferably deposited on an aluminum foil, wherein the heat transfer is improved by the dark color pigments and the coated aluminum foil is particularly suitable for use as grill foil. It is possible to achieve excellent adherence of the coating to the aluminum foil in this way for the temperature range between 200 and 400° C., as well as creasing resistance of the unit consisting of aluminum foil and coating. The aluminum foil, for example, has a thickness of approximately 12 μm while the coating thickness is 1 to 2 μm. Thus, the unit consisting of aluminum foil and coating can be crumpled up without peeling of spalling of the coating.

A grilling dish can furthermore be produced by deep-drawing the aluminum foil with coating, having an approximate thickness of 50 to 100 μm and preferably 80 μm. With an aluminum foil coated in this way, the coating does not separate off following a 2 hour cooking test. Further tests have proven that the coating can be wiped down (wet and dry) and has a high-gloss surface.

Instead of on an aluminum foil, the coating material can also be used for other items in the food sector, such as cooking and grilling equipment, frying pans, pots, Ceran® panels, waffle irons, baking sheets, ovens, fryers. A particularly good nonstick coating, e.g. for pans, can be obtained in this way by adding Teflon particles or fluoridation.

A different area of application for this coating are structural components subjected to heat, such as machine parts, motors, rotors, gears, heat exchangers, heating components, reflectors, solar system components. The coating ensures a good heat transfer for these components as well.

Non-black filler materials can also be used for creating optional color with the coating.

The present invention has created an emission-free, dark, flexible and deep-drawing surface coating that is resistant to high temperatures and absorbs radiated heat. The coating material is suitable for use in the food preparation area and can be used to coat metals, in particular metal foils, selected from aluminum, magnesium or ferrous alloys (steel). The coating material has a glass-type matrix that is organically flexible in the range of <25 weight %, which presents no problem for the food preparation, is filled with dark (preferably black) pigments that are non-poisonous with respect to the food preparation and has a layer thickness of <5 μm, in particular 0.4 μm to 2 μm.

The binding agent is composed preferably of silanes with four hydrolizable groups and/or silanes with 3 hydrolizable groups and a methyl group. A pigment, preferably carbon black, is dispersed in the binding agent in a concentration of 5-50 weight %. No admixture of auxiliary agents for dispersing the pigments, as well as for the flow of the coating agent, is required in this case.

With a metal foil coated in this way, preferably an aluminum foil, no odors or damaging gases are formed when it is heated. The metal foil in this case has a foil thickness of between 8 μm and 100 μm.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A high temperature degradation-resistant coating material for metal surfaces, comprising a binding agent and at least one filler material, wherein the binding agent comprises at least one siloxane with a residual organic share of less than 25 weight % and wherein said at least one siloxane comprises at least three cross-linking groups.

2. The coating material according to claim 1, wherein the coating material is degradation-resistant over a temperature range between the room temperature and 600° C., preferably between 100° C. and 400° C.

3. The coating material of claim 2, wherein the temperature range is from 100° C. to 400° C.

4. The coating material according to claim 1, wherein the coating material further comprises at least one condensation catalyst.

5. The coating material according to claim 1, wherein the coating material is in the form of a glass-type matrix, which protects the filler materials therein against combustion.

6. The coating material according to claim 1, wherein the binding agent is produced by means of a sol-gel process, and wherein said siloxane is a trifunctional or a tetra-functional siloxane.

7. The coating material according to claim 6, wherein the siloxane is at least one selected from the group consisting of methyltriethoxysilane and tetraethoxysilane.

8. The coating material according to claim 1, wherein the filler material is selected from the group consisting of carbon black and/or inorganic color pigments.

9. The coating material of claim 8, wherein the filler material is iron oxide black.

10. The coating material according to claim 1, which further comprises a solvent selected from the group consisting of ethanol, isopropanol, and admixtures thereof.

11. A coating supported on a surface, which is formed with a coating material as defined in claim 1.

12. The coating according to claim 11, wherein a coating surface is fluoridated for improving non-stick characteristics of the coating.

13. The coating according to claim 11, wherein the surface is that of a substrate selected from the group consisting of metal, glass, ceramics, glass-ceramics, plastic, natural compound, textiles, paper and leather.

14. The coating according to claim 11, wherein the coating is applied by immersion, spraying, or by means of a blade or roller.

15. The coating according to claim 11, which is filled or coated with fluorocarbon residues in the form of fluorocarbon resin particles.

16. The coating according to claim 11, wherein the coating is hardened by heating in a range between room temperature and 600° C., between 130° C. and 300° C., or with the aid of infrared radiation.

17. The coating according to claim 17, wherein the heating is conducted between 130° C. and 300° C.

18. An aluminum foil, in particular used for the cooking of food items, and a coating material as defined in claim 1, on at least one surface of the aluminum foil.

19. The aluminum foil according to claim 18, wherein the aluminum foil has a thickness between 9 μm and 20 μm and wherein the coating is thinner by less than half of said thickness.

20. The aluminum foil of claim 19, wherein the coating is in the range of 250 nm and 3 μm.

21. The aluminum foil according to claim 18, wherein the coating material is bonded to the aluminum foil such that it can be wiped down and is resistant to creasing.

22. The aluminum foil according to claim 18, wherein the aluminum foil has a thickness of 50 μm to 100 μm and is deep-drawn to form a grilling plate.

23. The aluminum foil according to claim 18, wherein the coating has a thickness of between 100 nm and 5 μm.

24. The aluminum foil according to claim 23, wherein coating thickness is between 250 nm and 3 μm.

25. A method for producing an aluminum foil with a dark surface comprising the following process steps:
applying a coating material according to claim 1 onto an aluminum foil and heating of the aluminum foil with the coating material to a temperature of at least 180° C., and hardening of the coating material.

26. The method of claim 25, wherein the heating temperature is at least 220° C.

27. The method according to claim 25, wherein the coating material is initially dried at a temperature of between 150° C. and 190° C. and is subsequently hardened at a higher temperature of between 180° C. and 290° C.
